(19) United States
(12) Patent Application Publication
(10) Pub. No.: US 2003/0010116 A1
(43) Pub. Date: Jan. 16, 2003

(54) Method and device for carrying out contractless measurement of a filling level

(76) Inventors: Paolo Cavazzin, Parma (IT); Egon Ahlers, Hamburg (DE); Uwe Hasler, Hamburg (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/204,793

(22) PCT Filed: Feb. 20, 2001
(86) PCT No.: PCT/EP01/01909

(30) Foreign Application Priority Data
Feb. 28, 2000 (DE) 10009406.6

(51) Int. Cl. G01F 23/00

(52) U.S. Cl. 73/290 V

(57) ABSTRACT

The invention relates to a method and a system for contactless measurement of the fill-level of a liquid in a container by transmitting a signal from above onto the liquid surface and by receiving the reflected signal, the reflected and received signal being compared by correlation with the transmitted signal in order to accurately determine the instant of reception and hence the path of travel.

The present invention relates to a method measuring in contactless manner a liquid's fill-level in a container as defined by the features of the preamble of claim 1. The invention furthermore concerns a device, hereafter called system, implementing the method and defined by the features of the preamble of claim 6.

Fill-level detectors based on mechanical principles are increasingly being replaced by fill-level detectors operating in contactless manner.

The known fill-level detectors operating on contactless principles all make use of a transmitter and a receiver, the transmitter generating waves which following reflection at the liquid surface are detected by the receiver. The path followed by said waves and the fill-level inferred from it are then calculated from the signal's travel time or phase difference.

In most procedures detecting the fill-level in contactless manner, both the transmitter and the receiver are configured some distance above the maximum liquid level. The transmitter emits a signal onto the liquid surface. Said signal is reflected at least in part at that surface and in this manner reaches the receiver, which displays the incoming signal. The travel time or the phase shift of the received signal allows determining the traveled path by using said signal's known speed of propagation and thereby the fill-level may be determined as the site of reflection. In the sense of the present invention, the term “signal” includes all waves that propagate at a known speed in a defined medium. As regards contactless fill-level detection, electromagnetic and acoustic waves are predominantly used. Said electromagnetic waves are microwaves and especially they shall be light.

All said contactless procedures incur the problem that it is difficult to identify the desired pattern in the received signal and accordingly the fill-level test results are unreliable. Depending on the physical nature of the transmitted signal, the reasons for such difficulties may vary considerably. Electromagnetic measurements raise problems because the motion of the liquid surface results in diffuse reflection. Ultrasonic measurements are affected by the pronounced damping of the volume of gas above the liquid level, in particular where liquids contain CO₂, entailing a low signal-to-noise ratio. Also certain reflections must be taken into account which take place not at the liquid's surface, but for instance at the container's base.

The European patent document 0 591 816 A2 discloses a procedure to measure a liquid's fill-level using both microwaves and the radar principle, whereby the fill-level is determined based on the particular signal reflected from the container's base rather than that reflected from the liquid's surface. The calculation of this fill-level is based on the travel time of the base signal, the actual distance to the base, the dielectric constant and the permeability. Accordingly this procedure only applies to liquids of precisely defined dielectric constants and permeabilities. However the noise substantially interferes in this instance too with the signal from the base and consequently this procedure fails to significantly improve the measurements.

The European patent document 4 327 333 A1 discloses a procedure for measuring by the radar principle the fill-level of a liquid in a container, the reliability of the measuring technique being improved by correcting for spurious signals, which are independent of the liquid's fill-level and which fall within a measured spectrum, by means of the measured strength of a first spurious signal. However this procedure may only succeed when all spurious signals exhibit similar strength patterns—which is not the case in general. Accordingly this procedure also is unsuitable to overcome the problems of measurement raised by the poor signal-to-noise ratio.

Therefore it is the objective of the present invention to create a method and a system implementing said method whereby reliable fill-level measurement may be carried out in spite of a poor signal-to-noise ratio and multiple reflections.

This problem is solved in the method of the invention by the characteristics of claim 1, the system implementing said method being defined by the characteristics of claim 6.

The heart of the invention is to detect the transmitted signal pattern contained in the received signal which results from the reflection at the liquid surface. Abstraction made of transmission interference, the received signal being perforce of the same shape as the transmitted one, said shape can be recognized in the received signal by resorting to signal processing known in the state of the art as correlation. Correlation is to be understood to mean the degree of similarity of two signals.

The German patent document 4,202,677 C1 discloses a particular mode of correlating. It shows a system—extraneous to that of the present invention—for testing a transmission path and transmitting a test signal of which the subsequent detection in the received signal flow is ascertained by comparison with the transmitted shape. In the express purpose of said procedure, it lacks test-signal synchronization and therefore determining the travel time also will be precluded.

The method of the invention may be carried out in versatile manner. In particular it may be carried out using a computer and its operational memory. On the other hand, hardware design allows attaining very high operational rates.

Moreover the method of the invention may be applied regardless of the physical nature of the transmission signal as long as the signal contains a recognizable pattern the shape of which allows correlation. The transmitter and receiver must be selected according to the kind of signal. Optionally the transmitter and the receiver may be configured as one component.

In principle the transmitted signal may include an arbitrary pattern, in particular it may be frequency- or pulse-modulated. Solely the pattern delectability in the presence of any interference signals or noise shall be determinant. Accordingly the concept of “pattern” is very broad.

In particularly advantageous manner and as defined in claim 2 or claim 7, the pattern of the transmitted signal shall be a square pulse the characteristic width of which substantially shall constitute the pulse width. The advantage of this simple pattern is that the signal strength is not needed as an information carrier and consequently the received signal can be normalized without thereby falsifying its information content. Thereupon the normalized received signal can be converted in simple manner into a bit pattern which in turn also can be compared in simple manner with a comparison bit pattern. The bit-by-bit comparison made possible in this way offers the advantage of requiring only little computer power for the comparison. The technical procedures to normalize the received signal, to convert latter into a bit pattern and to compare the bit pattern bit by bit with another, predetermined bit pattern, are well known to the expert. Special care must be paid, especially as regards patterns of simple shapes such as square pulses, that the A/D converters sampling rate be sufficiently high. In other words, in the present example of a square pulse, this pulse must be represented by a sufficient number of converted received values, in particular bits. Satisfactory results may be expected if for instance the square pulse is represented by four bits. In general, the probability of random agreement between reference values and received values shall drop as the sampling rate increases.

The identification of the transmitted-signal pattern may be improved in that the pattern consists of a train of square pulses in the manner advantageously proposed in claims 3 and 8. This pulse train also can be converted after normalization into a bit pattern of which the information consists of the square-pulse widths and the size of the gaps between pulses. Using a pulse train offers the advantage that random coincidences between control and received values become more improbable.

The signal from the transmitter shall be reflected not only at the surface of the liquid but also at the container base. The signal reflected from the liquid surface reaches the receiver earlier than the signal reflected from the container base. However a second measurement of fill-level must wait until the container-base signal has reached the detector in order to avert confusing the container-base signal with the surface signal of the next fill-level measurement. This constraint sets a lower limit on the time interval between two consecutive fill-level measurements. Accordingly and advantageously as defined in claims 4 and 9, the pattern of the transmitted signal shall be different where time-consecutive fill-level measurements are undertaken. This goal for instance may be attained by selecting the pattern randomly or by specifying a fixed processing sequence of predetermined and stored patterns.

The time interval between consecutive fill-level measurements may be substantially reduced since a first fill-level signal reflected from the liquid surface cannot be construed being a second fill-level measurement signal reflected from that liquid surface because the patterns now are different. It is understood that the stored sequence of reference values must be correspondingly matched in case of signal pattern change to the new pattern before there is comparison by correlation.

Advantageously and as defined in claims 5 and 11, a test signal is generated by reflecting the transmitter's signal at a reflection site of defined spacing from the transmitter and receiver and it shall be used to ascertain a correction value. The signal's speed of propagation depends on environmental conditions, in particular the temperature and the pressures when the container is being filled. These changes may be taken into account by having the transmitted signal travel along a known path, by determining the travel time, and from this information calculating the travel speed, i.e., the propagation speed. This known travel path is produced by setting up a reflection site of which the distance to transmitter and receiver is known. Accordingly the receiver first receives the reflection signal formed at said reflection site and only thereafter the signal reflected from the liquid surface. Based on a first-ascertained match between the received-signal pattern and the transmitted signal pattern, a signal speed of propagation may be determined on the basis of which a second ascertained match of the received signal pattern and the known shape of the transmitted signal can be converted by calculation into the magnitude of a traveled path from which the fill-level can then be ascertained.

As regards the system implementing the method of the present invention, it is advantageous, as defined in claim 10, to mount the transmitter and the receiver in the gas return duct of the filling element by means of which the container may be loaded with liquid. The gas return duct assures an unobstructed path to the liquid in the container, and therefore additional access is not needed when the transmitter and the receiver are configured in said path.

Advantageously according to claim 12, the reflection site is configured as a constriction of the gas return path. In particular the present invention proposes to situate this constriction at the lower end of said duct.

Further details and features of the invention are elucidated in the description below relating to the embodiments of the invention shown in the attached drawings.

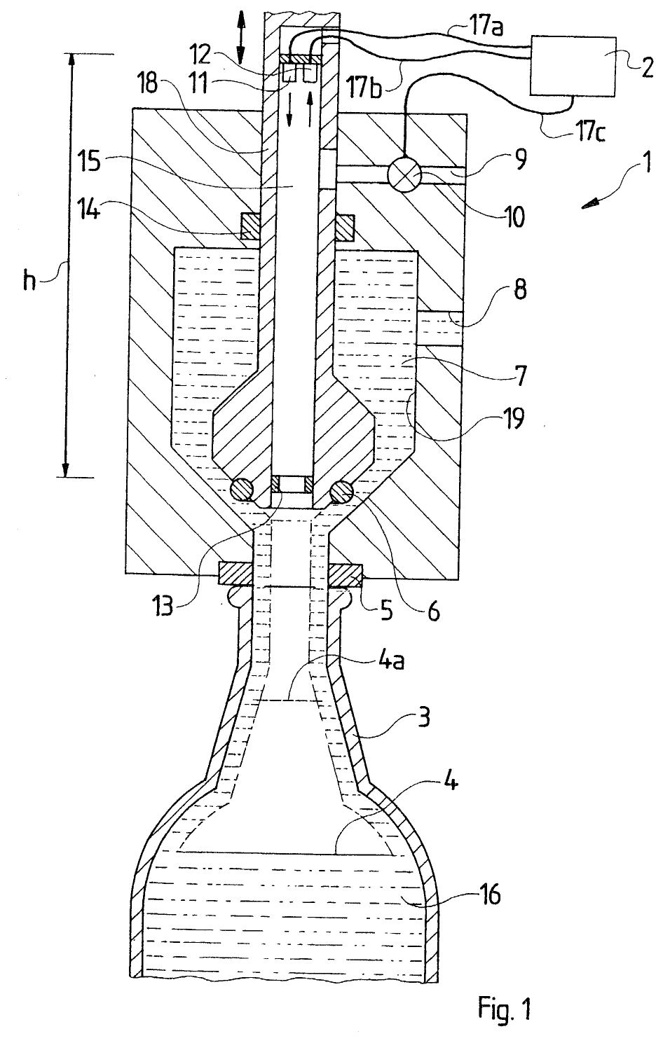

FIG. 1 is a section of filling equipment equipped with the system of the invention,

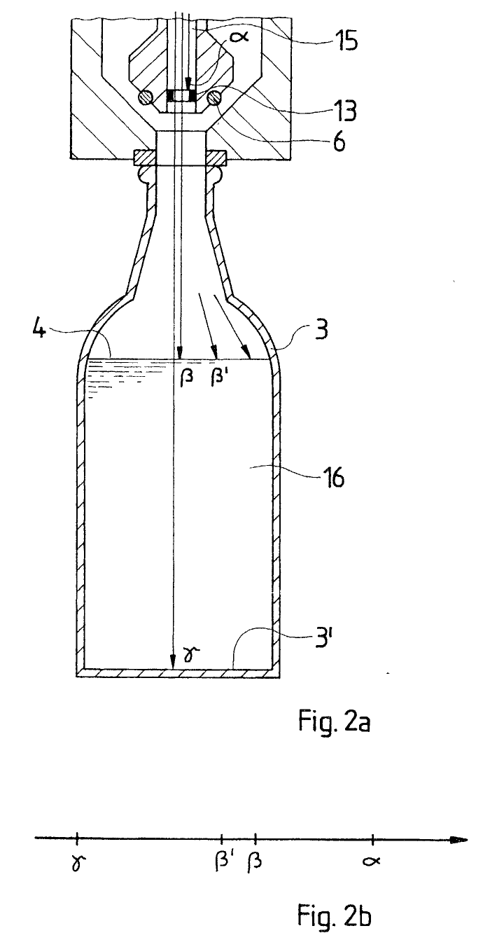

FIG. 2a schematically shows a liquid-filled bottle with different reflection surfaces,

FIG. 2b schematically shows a signal received from the reflection surfaces of FIG. 2a,

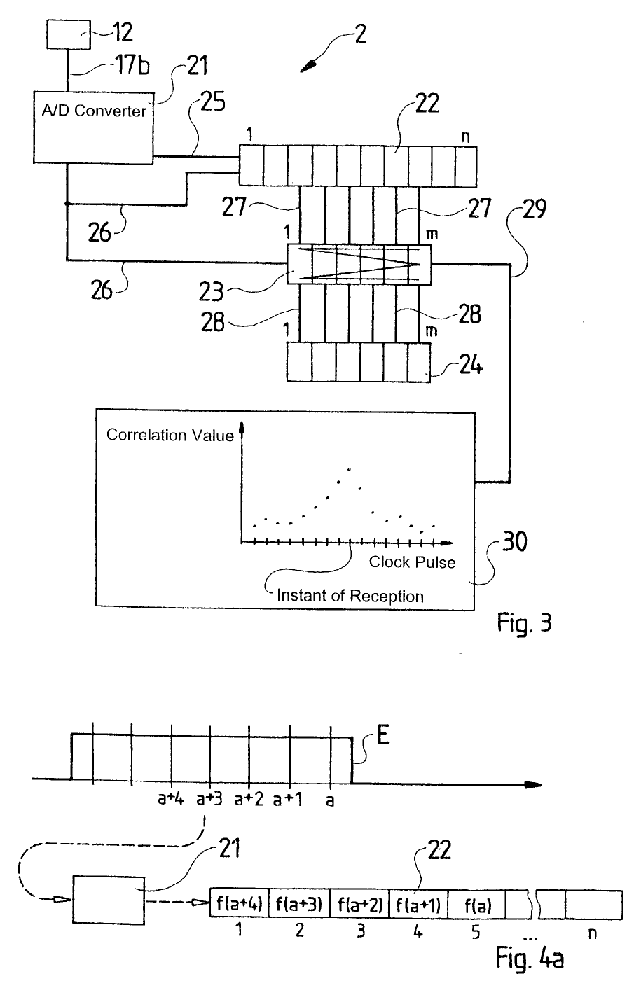

FIG. 3 is a functional block diagram of the analyzer of the invention,

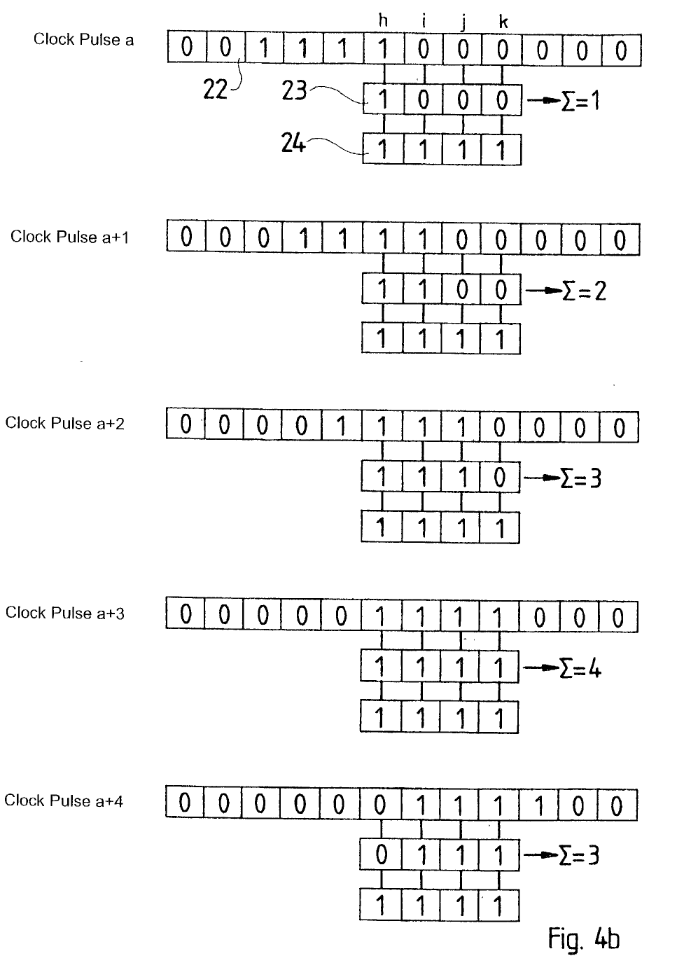

FIG. 4a schematically shows the sampling and conversion process of the received signal,

FIG. 4b schematically shows the correlation carried out in synchronism with the converter in the form of illustrative bit patterns, and

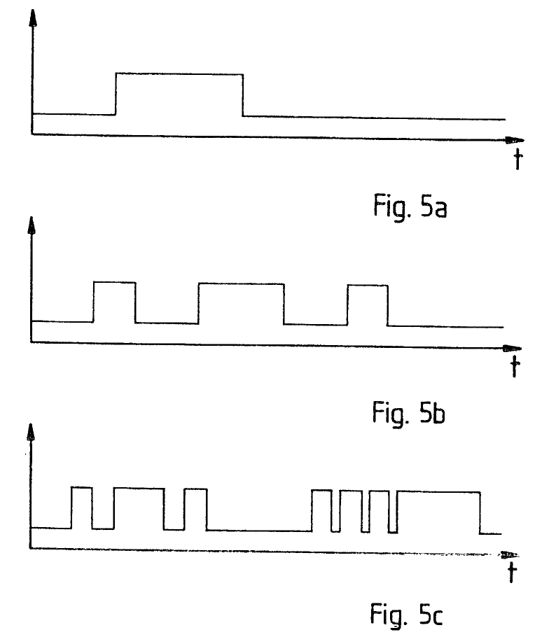

FIGS. 5a, b, c show illustrative patterns of the transmitted signal.

The illustrative embodiment shown in FIG. 1 shall elucidate both the method of the invention and a system of the invention used in measuring in contactless manner the fill-level of a liquid 16 in a container 3. A filling equipment 1 used for the above purpose is fitted with a filling feed 8 and a gas-return conduit 9 at a filling machine (omitted), which may be conventional.

The filling equipment 1 comprises a filling-substance chamber 19 holding the liquid filling substance 7. Said filling equipment 1 furthermore comprises a sealed, pressure-tight gas-return element 18 which is displaceable up and down and of which the lower part runs as far as into the filling-substance chamber 19. Tightness to pressure is achieved using a slidable seal 14 configured above the filling-substance chamber 19. An elongated cylindrical duct is configured inside the gas-return element 18 and acts as the gas-return duct 15, gas being able to flow into and out of said cylindrical conduit when the container 3 is being filled with the filling substance 7, said container 3 being forced by an omitted compressing element against a container seal 5 and the filling equipment 1.

A transmitter 11 and a receiver 12 connected by signal lines 17a, 17b to an analyzer 2 are mounted to the upper end of the gas return duct 15. The analyzer 2 controls the transmitter 11 by feeding control signals through the signal line 17a to the transmitter 11 and it analyzes the signals received by the receiver 12 to determine a travel time of the signal emitted by the transmitter 11, the received signal being fed through the signal line 17b. The signal emitted by the transmitter 11 toward the liquid surface 4 passes through the gas return duct 15 and a first portion of said signal will be reflected at a constriction 13 configured at the lower end of the gas return duct 15; a second signal portion arrives at the liquid surface 4 where it is partly reflected. Said reflected signal also passes through the gas return duct 15 to reach the receiver 12, the received signal passing through the signal line 17b into the analyzer 2.

Because the vertical gap h between the constriction 13 and the transmitter 11 and the receiver 12 is known, the travel time of the first reflected signal allows determining the signal speed of propagation which in turn allows calculating the travel path of the signal reflected by the liquid surface 4. Once the liquid surface 4 has reached the maximum fill-level 4a, which in this instance shall be the nominal fill-level, the analyzer 2 shall control through the signal line 17c a valve 10 in the gas return conduit 9 in a manner that said valve moves into the closed state. In any case, the feed of the filling substance 7 shall be interrupted because the movable and sealed gas return element 18 shall be shifted upward until the O-ring 6 comes to rest against the lower wall of the filling-substance chamber 19.

Next the container 3 is released from its compression against the seal 5 and is then moved away, for instance to a closing machine. To get ready for a new filling step, a new container 3 is forced against the seal 5. The container 3 is prestressed when the valve 10 in the gas return conduit 9 is opened. By moving up the gas return element 18, the next feed of filling substance 7 shall then take place.

To the extent described above, said filling equipment still is known apparatus of the state of the art of this species.

FIG. 2a shows that the signal emitted by the transmitter 11 toward the liquid surface 4 is reflected at several locations. A first reflection a occurs at a constriction 13 of the gas return duct 15. A second reflection β occurs at the liquid surface 4, from which it is reflected not only along the shortest vertical path to the transmitter 11 but also from the zones (β=) away from said surface's center. A third signal portion crosses all the liquid 16 in the container 3 and is reflected (γ) at said container's base 3′. FIG. 2b shows schematically the signal incident on the receiver 12. The reflected signal α reaches the receiver before the signal β, the signals β= and the signal γ will. The reflected signal α allows determining signal speed of propagation at the prevailing temperature and pressure, the vertical height h being known and the time of travel being determined. Using said speed of propagation, the path covered by the second incoming, reflected signal β may be computed with knowing this signal's travel time.

The discussion below elucidates the identification of the incoming reflected signals. For that purpose and as schematically shown in FIG. 3, the identification unit 2 comprises an A/D converter 21 that is loaded through the signal line 17b with the received signal of the receiver 12. The A/D converter rapidly samples this received signal and converts it into digital values. The converted values are fed through a signal line 25 into a shift register 22 comprising places 1 through n.

The analyzer 2 furthermore includes a memory 24, which stores reference values in the storage places 1 through m, the reference values representing the shape of the transmitted signal. The memory 24 can store in permanent or in overwrite manner. The comparison of the reference values in the memory 24 with the received values which are consecutively shifted at the converter clock rate in the shift register 22 is carried out in a correlation unit 23 also containing places 1 through m. For that purpose both the shift register 22 and the correlation unit 23 are connected through the clock-rate line 26 with the A/D converter 21, whereby both are timed at the rate of the converter clock. The correlation unit is connected place by place through signal lines 27 to the shift register 22 and furthermore through signal lines 28 to the memory 24. The received values and the reference values to be compared are fed through these signal lines 27, 28 and at the clock rate of A/D converter 21 into the correlation unit 23 to be compared for instance by binary multiplication. The outcome of this comparison represents the correlation value. Said value is fed through a signal line 29 at the converter clock rate to an analyzer 30 that determines the instant of reception because the maximum correlation value may be assigned to the instant of a clock pulse and this clock pulse instant of maximum correlation corresponds to the instant of reception.

FIGS. 4a and 4b elucidate an illustrative implementation of the time sequence of sampling and converting.

FIG. 4a shows how the A/D converter 21 samples in clock pulse manner the received signal E at the clock instants a, a+1 . . . a+4 and how the sampled value is fed into the shift register 22 in the form of samples values f(a) . . . f(a+4) at the storage places 1 through n of said register.

FIG. 4b elucidates the operation of the correlation unit 23 by the example of a received signal in the form 1|1|1|1. The sequence of received values moves through the shift register 22 at the shifting clock rate of the A/D converter 21. The values in the adjacent places h, i, j and k are compared in the correlation unit 23 with the values 1|1|1|1 stored in the memory 24. With each new clock pulse, the pattern 1|1|1|1 to be identified and contained in the received values shall be consecutively shifted inside the shift register 22 until it shall occupy the memory places h, i, j and k at the clock pulse a+3, whereupon the correlation shall be a maximum value of 4 which will again decrease thereafter. The presence of the maximum correlation value may be ascertained for instance by comparison with a predetermined value.

FIG. 5 shows preferred examples of transmitted signal patterns. FIG. 5a shows a typical square wave of defined width, FIG. 5b shows a train of square pulses consisting of a narrow, a wide and again a narrow square pulse, and FIG. 5c shows two consecutive square pulse trains of different patterns. The first pulse train consists of a narrow, a wide and again a narrow pulse, and the second pulse train consists first of three narrow pulses then a wide one.

The correlation procedure described above in relation to FIGS. 3 and 4 makes use of a very simple correlation algorithm whereby the particular places in the converter 21 and memory 24 are multiplied and then added. This method however is suitable only to identify simple, cohesive pulses as shown in FIG. 5a because only values other than zero contribute to the correlation. But more complex correlation algorithms also may be used in order to compare the shape of more complex patterns also containing gaps, that is, values of zero, as shown in FIGS. 5b and 5c.

On account of the above correlation comparison of the stored pattern and the pattern being received, which is distorted by interference and noise, such a pattern also may be identified in the presence of strong interference and very low signal-to-noise ratios. When using complex patterns such as illustrated in FIG. 5c, and if the sampling rate is high enough, highly accurate correlation is attained whereby the individual pattern shape may be identified.

If different pattern shapes are used from measurement to measurement, for instance by varying the pattern shown in FIG. 5c, reliable identification of the expected pattern may be expected, that is, as indicated with respect to FIG. 2, and as regards closely following patterns, the first reflection β can reliably be distinguished from another pattern (reflection γ) arriving after a longer travel time from the base and still belonging to the previous measurement. As a result the rate of taking measurements may be selected to be very high and a liquid level rising rapidly when a container is being quickly filled can thus be monitored very accurately by means of closely following measurements.

As regards the discussion relating to FIGS. 4b and 5, square-pulse patterns are considered offering the option of normalizing the correlation and hence a reduction in computational complexity. However the invention also applies to amplitude-modulated patterns for instance in the form of sine waves. With respect to such patterns, the A/D converter must render the signal strength received at each converter clock pulse in the form of a value. Correspondingly the original pattern stored in the memory 24 must contain the values of corresponding amplitudes. In the correlation, the amplitudes always must be compared for similarity.

1. A method for measuring in contactless manner the fill-level of a liquid (16) in a container (3), whereby a transmitter (11) configured above the maximum liquid level (4a) emits a signal toward the liquid level (4), and where a receiver (12) also configured a distance above the maximum liquid level (4a) picks up a transmitter signal which among other signals includes that reflected from the liquid surface (4), the signal travel time from the transmitter (11) to the receiver (12) being determined and the travel path being computed and the fill-level being determined from said determined travel path, characterized in that
the signal received at the receiver (12) being sampled and converted at a high sampling rate by an A/D converter (21), the time interval between two sampling and conversion procedures being significantly less than the pulse width or the half-period of the transmitted signal,
the A/D converter (21) consecutively feeds the converted received-signal values at the converter clock rate into a shift register (22) whereby a sequence of received signal values is formed in said register, said sequence reproducing the shape of the received signal,
the sequence fed into the shift register (22) is compared at the clock rate and by means of correlation with a stored sequence of reference values, whereby a sequence of correlation values is generated, the sequence of reference values reproducing at least predominantly the shape of the pattern of the transmitted signal emitted from the transmitter (11),
the instant of maximum correlation is determined from the sequence of correlation values as the instant of reception from which the signal travel time from the transmitter (11) to the receiver (12) is determined.

2. Method as claimed in claim 1, characterized in that a signal is emitted from the transmitter (11) having its pattern in the form of a square pulse.

3. Method as claimed in claim 1, characterized in that a signal is emitted from the transmitter (11) having its pattern in the form of a train of square pulses.

4. Method as claimed in either of claims 2 and 3, characterized in that the pattern is varied with time-consecutive fill-level measurements.

5. Method as claimed in claim 1, characterized in that a reference signal is generated by reflecting the transmitter signal emitted by the transmitter (11) at a reflection site (13) which is configured a defined distance (h) from the transmitter (11) and receiver (12) and that said reference signal is analyzed to determine a correction value.

6. A system for measuring in contactless manner the fill-level of a liquid (16) in a container (3) and comprising at a distance above the maximum liquid level (4a) a transmitter (11) to emit a signal containing an identifiable pattern toward the liquid level (4), said system moreover containing a receiver (12) which also is configured a distance above the maximum liquid fill-level (4a) and which detects a received signal which also contains the emitted signal reflected from the liquid surface (4), further containing an analyzer (2) to acquire the travel time of said signal from the transmitter (11) to the receiver (12) and to calculate the length of the path traveled and from the latter the fill-level, characterized in that
the analyzer (2) comprises an A/D converter (21) designed in a manner that the received signal acquired by the receiver (12) can be applied to said converter's input and that said converter allows sampling and converting with high sampling rate the received signal, the time interval between two sampling and converting processes being clearly smaller than the pulse width or the half period of the pattern of the transmitted signal,
the analyzer (2) moreover comprises a shift register (22) which is consecutively fed with received signal values converted by the A/D converter (2) at the converter clock rate in a manner that a sequence of received values may be generated, said sequence reproducing the shape of the received signal, and
the analyzer (2) comprises a correlation unit (23) wherein the sequence of received signal values fed into the shift register (22) may be compared, by means of correlation and at the converter clock pulse rate—with a sequence of reference values stored in a memory (24), to generate a sequence of correlation values, the sequence of the reference values corresponding at least substantially to the shape of the pattern of the signal emitted by the transmitter (11), said correlation unit (23) allowing determining—from the sequence of correlation values—the instant of maximum correlation as being the instant of reception from which the travel time of the signal from the transmitter (11) to the receiver (12) can be determined.

7. System as claimed in claim 6, characterized in that the pattern is a square pulse.

8. System as claimed in claim 6, characterized in that the pattern is a train of square pulses.

9. System as claimed in either of claims 7 and 8, characterized in that the transmitter (11) is designed to transmit different patterns with time-consecutive fill-level measurements.

10. System as claimed in claim 6, characterized in that the transmitter (11) and receiver (12) are configured in the gas return duct (15) of the filling equipment (1) filling the container (3) with liquid.

11. System as claimed in claim 6, characterized in that a reflection site (13) is configured at a known distance (h) underneath the transmitter (11) and receiver (12) and a distance above the maximum liquid level (4a) and allows generating a test signal by reflecting the signal transmitted from the transmitter (11).

12. System as claimed in claim 11, characterized in that the reflection site (13) is in the form of a constriction of the gas return duct (15), in particular as a constriction at the lower end of the gas return duct (15).
